(19) United States
(12) Patent Application Publication
(10) Pub. No.: US 2025/0132374 A1
(43) Pub. Date: Apr. 24, 2025

(54) METHOD FOR POST-FORMING OF STIFFENING PORTIONS IN ENCLOSURES FOR BATTERY CELLS

(71) Applicant: GM GLOBAL TECHNOLOGY OPERATIONS LLC, Detroit, MI (US)

(72) Inventors: Andrew Clay BOBEL, Troy, MI (US); Michael Apone, Fraser, MI (US); Diptak Bhattacharya, Royal Oak, MI (US)

(21) Appl. No.: 18/492,145

(22) Filed: Oct. 23, 2023

(51) Int. Cl. H01M 10/04; H01M 50/119; H01M 50/131

(52) U.S. Cl. CPC H01M 10/0481; H01M 50/119; H01M 50/131

(57) ABSTRACT

An enclosure body and a method for manufacturing an enclosure includes one of extruding and deep drawing an enclosure including a plurality of side walls defining a first cavity. The plurality of side walls are formed without stiffening portions. After extruding and deep drawing of the enclosure, forming a plurality of stiffening portions on the enclosure using an expandable punch, a hydraulic punch, and/or hydroforming.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to enclosures, and more particularly to enclosures including post-formed stiffening portions.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A method for manufacturing an enclosure body includes one of extruding and deep drawing an enclosure body including a plurality of side walls defining a first cavity, wherein the plurality of side walls are formed without stiffening portions; and after the one of the extruding and deep drawing of the enclosure body, forming a plurality of stiffening portions on the enclosure body.

In other features, forming the plurality of stiffening portions includes surrounding the plurality of side walls of the enclosure body using a die; and inserting an outer punch of an expandable physical punch into the first cavity of the enclosure body. The outer punch includes a plurality of punches and a plurality of side walls defining a second cavity and a plurality of side wall cavities configured to receive the plurality of punches. The method includes inserting an inner punch in the second cavity to bias the plurality of punches from a withdrawn position to a stamping position to stamp a plurality of stiffening portions in at least one of the plurality of side walls of the enclosure body.

In other features, the plurality of stiffening portions comprise at least one of a dimple and a stiffening bead, and the enclosure body is made of one of stainless steel, aluminum, and alloys thereof.

In other features, the plurality of stiffening portions extend outwardly from an outer side surface of the enclosure body. The plurality of punches include a body and a projection extending transversely from the body. The method includes biasing the projection of the plurality of punches using a spring towards the withdrawn position of the plurality of punches. The plurality of side wall cavities include first inclined surfaces and the plurality of punches includes bodies with second inclined surfaces.

In other features, the plurality of punches are inclined at an acute angle relative to a direction that the inner punch moves. The plurality of punches move in a direction that is transverse relative to a direction that the inner punch moves. Edges of inner ends of the plurality of punches are inclined at an acute angle relative to a direction that the inner punch moves.

In other features, a first pattern of the stiffening portions on one of the plurality of side walls of the enclosure body is complementary to a second pattern of the stiffening portions on another one of the plurality of side walls of the enclosure body to allow nesting of adjacent ones of the enclosure body.

In other features, forming the plurality of stiffening portions includes surrounding the plurality of side walls of the enclosure body using a die; and inserting an outer punch of an expandable physical punch into the first cavity of the enclosure body. The outer punch includes a plurality of punches and a plurality of side walls defining a second cavity and a plurality of side wall cavities configured to receive the plurality of punches. The method includes sealing the second cavity; supplying liquid to the second cavity; and biasing the plurality of punches into the plurality of side walls of the enclosure body using the liquid to stamp a plurality of stiffening portions in the plurality of side walls of the enclosure body.

In other features, the method includes sealing the plurality of punches relative to the side wall cavities. Sealing the plurality of punches relative to the plurality of side wall cavities includes arranging an “O”-ring between the plurality of punches and the plurality of side wall cavities.

In other features, forming the plurality of stiffening portions includes surrounding the plurality of side walls of the enclosure body using a die including a plurality of second cavities; and using liquid in the first cavity of the enclosure body to drive the side walls into the plurality of second cavities to create a plurality of stiffening portions on the side walls of the enclosure body.

A battery enclosure comprises an enclosure body formed by one of extruding and deep drawing and including a plurality of side walls defining a first cavity. A plurality of stiffening portions are formed in at least one of the plurality of side walls of the enclosure body.

In other features, the plurality of stiffening portions comprise at least one of a dimple and a stiffening bead. The enclosure body is made of one of stainless steel, aluminum, and alloys thereof. The plurality of stiffening portions extend outwardly from an outer side surface of the enclosure body. A first pattern of the stiffening portions on one of the plurality of side walls of the enclosure body is complementary to a second pattern of the stiffening portions on another one of the plurality of side walls of the enclosure body to allow nesting of adjacent ones of the enclosure body.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including cathode electrodes, anode electrodes, and separators arranged in a battery cell enclosure according to the present disclosure;

FIG. 2A is a perspective view of an example of a battery cell enclosure;

FIG. 2B is a perspective view of an example of a battery cell enclosure with a pressure-based vent cap;

FIGS. 3A to 3C are perspective views of examples of enclosures for battery cells with post-formed stiffening portions according to the present disclosure;

FIGS. 4A to 4C are perspective and side views illustrating an example of a nesting of the battery cells with post-formed stiffening beads according to the present disclosure;

FIGS. 5A to 5C are perspective and side views illustrating an example of nesting of the battery cell with post-formed stiffening dimples according to the present disclosure;

FIG. 6A to 6C are perspective views of examples of enclosures with post-formed stiffening portions for battery cells according to the present disclosure;

FIGS. 7A to 7B are functional block diagrams illustrating a tool for stamping stiffening portions in enclosures using a physical or hydraulic punch or hydroforming according to the present disclosure;

FIGS. 8A to 8D are side cross sectional views of examples of expandable physical punches according to the present disclosure;

FIGS. 9A to 9B are side cross sectional views of an example of hydroforming according to the present disclosure;

FIGS. 10A to 10B are side cross sectional views of an example of an expandable hydraulic punch according to the present disclosure; and

FIGS. 11A to 11C are side cross sectional views of examples of expandable physical punches according to the present disclosure.

In the drawings, reference numbers may be reused to identify similar and/or identical elements.

### DETAILED DESCRIPTION

While enclosures according to the present disclosure are shown in the context of battery cells for electric vehicles, the enclosures can be used in stationary applications and/or other applications.

Battery cells are arranged in enclosures such as prismatic and cylindrical enclosures that are made of metal such as stainless steel, aluminum, or other metal. During cycling of the battery cells, side walls of the battery cells may bulge due to internal pressure. Conventional prismatic enclosures are made from aluminum using extrusion or deep drawing methods. However, the enclosures made using this approach are not sufficiently stiff to prevent bulging due to the internal pressure.

Simple vertical stiffening beads that extend to an open edge of the enclosure (to allow removal from a die) have been used to stiffen flat surfaces of metal enclosures manufactured using extrusion or deep drawing methods. However, more complex stiffening beads and/or dimples are not possible when extrusion or deep drawing methods are used.

The present disclosure relates to methods for post-forming stiffening portions (e.g., beads, dimples, manufacturer logos, and/or other shapes) after the enclosure body is made (e.g., using extrusion or deep drawing methods). The method embosses outward-facing stiffening portions (e.g., shallow beads, dimples, and/or other shapes) on side walls of the pre-made enclosure using an expandable physical or hydraulic punch or hydroforming. In some examples, the enclosure body (without the stiffening portions) is made using a conventional 2-piece or 3-piece process (such as extrusion methods, deep drawing methods, or other methods).

After the enclosure is manufactured, the enclosure is arranged in a die including cavities corresponding to locations of the stiffening beads and/or dimples on the enclosure body. In some examples, an expandable physical or hydraulic punch is inserted into the enclosure body with one or more punches in a withdrawn position. The one or more punches are physically or hydraulically extended into one or more side walls of the enclosure body to stamp stiffening portions on the one or more side walls. In other examples, hydroforming is used.

The stiffening portions can have a variety of shapes including stiffening beads, dimples, or other geometric shapes such as manufacturer logos. The stiffening portions can be arranged in any location or direction on wide and/or narrow side walls of the enclosure. After formation, the stiffening portions geometrically stiffen the side walls (and/or around edges) of the enclosure body. The stiffening portions strengthen the enclosure body for a given side wall thickness. Alternately, the stiffening portions enable the use of thinner metal material for the side walls of the enclosure body which reduces weight without sacrificing strength and/or stiffness. The stiffening portions can also be used to define gas flow channels that are used to direct the flow of hot vent gases to the vent during thermal events.

In some examples, the stiffening portions have a depth in a range from 0.2 to 1.0 times a thickness of the enclosure walls. In some examples, a width of the bead is in a range from 2 mm to 6 mm. In some examples, the stiffening portions comprise stiffening beads extending horizontally, vertically, and/or diagonally. In some examples, a first pattern of stiffening portions on one side of the enclosure body is complementary to a second pattern of stiffening portions on another side of the enclosure body to allow nesting of adjacent enclosures, which saves packaging space.

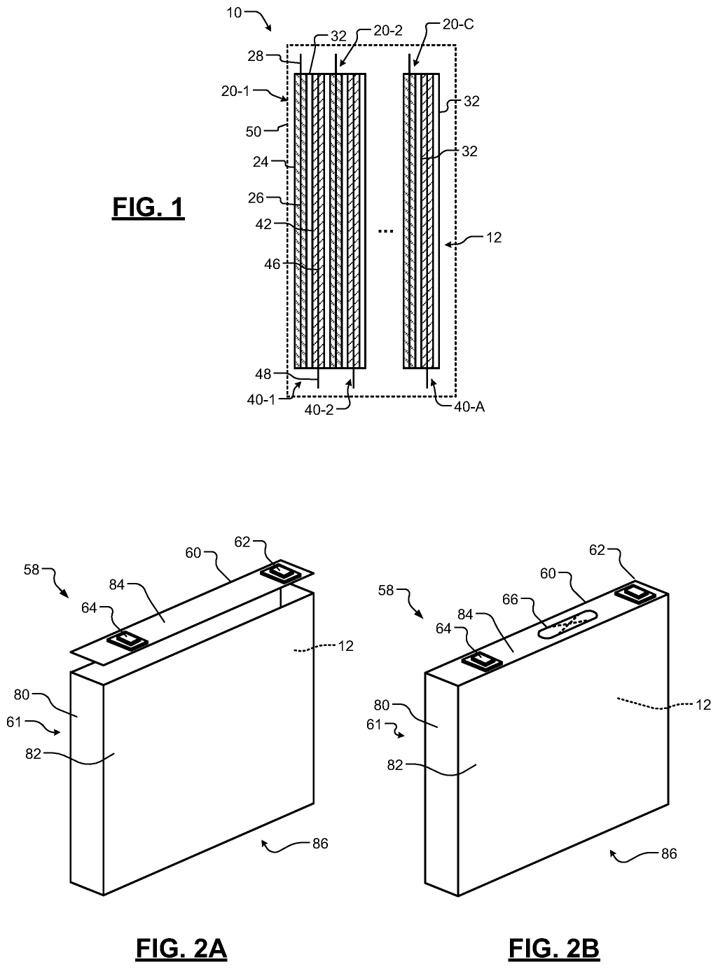

Referring now to FIG. 1, a battery cell 10 includes C cathode electrodes 20, A anode electrodes 40, and S separators 32 arranged in a predetermined sequence in a stack 12 located in an enclosure 50, where A, C, and S are integers greater than one. The C cathode electrodes 20-1, 20-2, . . . , and 20-C include cathode active layers 24 arranged on one or both sides of cathode current collectors 26. The A anode electrodes 40-1, 40-2, . . . , and 40-A include anode active layers 42 arranged on one or both sides of the anode current collectors 46.

In some examples, the anode active layers 42 and/or the cathode active layers 24 are free-standing electrodes that are arranged adjacent to (or attached to) the current collectors. In some examples, the anode active layers 42 and/or the cathode active layers 24 comprise coatings including one or more active materials, one or more conductive fillers/additives, and/or one or more binder materials. In some examples, the cathode current collectors 26 and/or the anode current collectors 46 comprise a foil, mesh, and/or expanded metal layer.

In some examples, the current collectors are made of one or more materials selected from a group consisting of copper, stainless steel, brass, bronze, zinc, aluminum, and/or alloys thereof. In some examples, external tabs 28 and 48 connected to the current collectors of the cathode electrodes and anode electrodes are located on opposite sides of the battery stack (as shown in FIG. 1), on different sides, or on the same side of the battery stack.

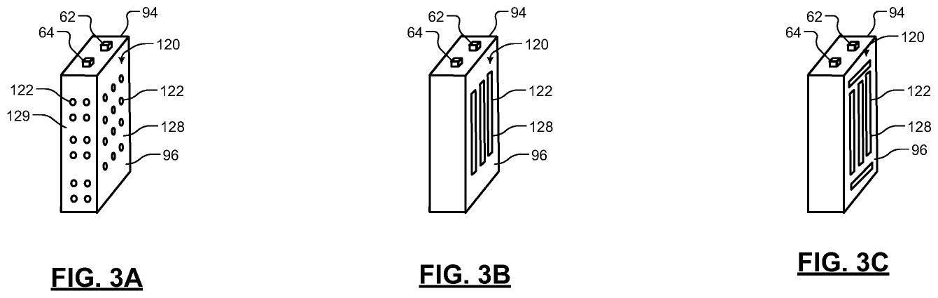

Referring now to FIGS. 2A and 2B, a battery cell 58 includes an enclosure 60. In some examples, the enclosure 60 has a prismatic shape with rectangular cross-sections in x-, y- and z-axis planes. In some examples, the enclosure 60 includes an enclosure body 61 including sides 80 and 82 defining an open-ended rectangular prism. In some examples, the sides 80 have a narrower width than the sides 82. In some examples, the enclosure 60 includes the bottom portion 86. In other examples, the bottom portion 86 is attached after the enclosure 60 is formed. In some examples, the enclosure body is made using extrusion methods, deep drawing methods, or other methods.

A lid portion 84 and optionally the bottom portion 86 are attached to the enclosure body 61 to enclose top and the bottom openings of the enclosure body 61, respectively. The battery cell 58 includes external terminals 62 and 64 that pass through the lid portion 84. The stack 12 of the C cathode electrodes 20, the A anode electrodes 40, and the S separators 32 is arranged in the enclosure 60.

The external terminals 62 and 64 are connected to external tabs 28 and 48 of the C cathode electrodes 20 and the A anode electrodes 40, respectively. In FIG. 2A, the lid portion 84 does not include a pressure-based vent cap. In FIG. 2B, the lid portion 84 (and/or the bottom portion 86) includes a pressure-based vent cap 66. The pressure-based vent cap 66 is configured to release vent gases when pressure within the inner enclosure is greater than a predetermined pressure.

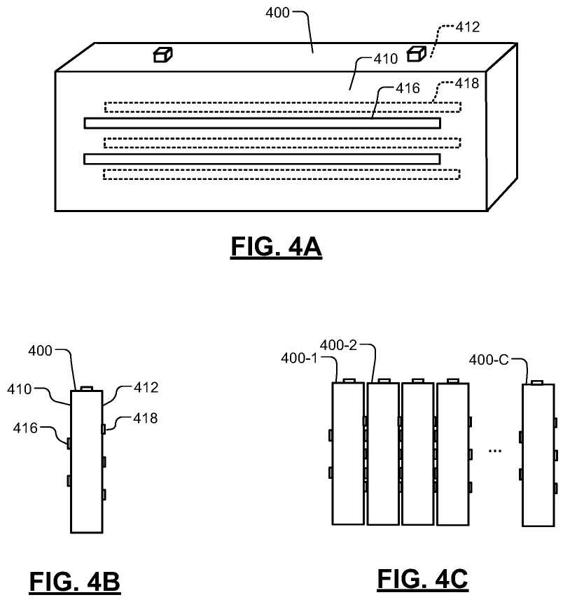

Referring now to FIGS. 3A to 3C, a battery cell 94 includes an enclosure 96 with one or more side surfaces 128 including a plurality of stiffening portions 122. While the stiffening portions 122 include dimples, the stiffening portions 122 can have different shapes such as beads or other shapes. In some examples, the dimples have a rectangular, hemispherical, and/or arcuate shape. As can be appreciated, the stiffening portions 122 can be arranged on other side surface 129, the lid, and/or the bottom.

In some examples, the stiffening portions 122 are arranged in a predetermined pattern 120 on the side surface 128 of the battery cell 94. In some examples, the stiffening portions 122 are arranged on surfaces of the enclosure 96 that have the largest area. In some examples, two or more side surfaces of the battery cell 94 have the same pattern of stiffening portions 122. In other examples, opposite side surfaces of the battery cell 94 have different patterns of the stiffening portions 122.

In FIG. 3A, the stiffening portions 122 include dimples that extend outwardly from the side surface 128 of the enclosure 96. In some examples, when two or more of the battery cells 94 are arranged adjacent to one another, the stiffening portions 122 of facing side surfaces of adjacent battery cells are offset to allow nesting. In some examples, a thermal insulating layer or a thermal interface material and a cooling plate are arranged between adjacent battery cells.

In FIGS. 3B and 3C, the stiffening portions 122 comprise stiffening beads or ribs having a rectangular cross section. The stiffening portions 122 extend vertically, horizontally, and/or diagonally along one or more of the side surfaces. The stiffening portions 122 are arranged in a first predetermined pattern on one side of the battery cell 94 and a second predetermined pattern on an opposite side surface of the battery cell 94.

In some examples, the first predetermined pattern and the second predetermined pattern are the same. In other examples, the stiffening portions of the first predetermined pattern and the second predetermined pattern are different. For example, the stiffening portions on one side are complementary to allow nesting or overlapping to minimize space (e.g., offset relative to the stiffening portions on the opposite side). In other words, adjacent ones of the battery cells can be arranged in close proximity (e.g., with the stiffening portions in a nesting or interleaved pattern when aligned and/or positioned adjacent to one another).

In some examples, a backside volume created by the stiffening portions is used to direct vent gases within the enclosure to the vent. In other examples, the backside volume is filled with a material to provide a smooth surface. In other examples, the material comprises an insulating material or thermal interface material. In other examples, the material comprises a first suppressant material such as sodium bicarbonate.

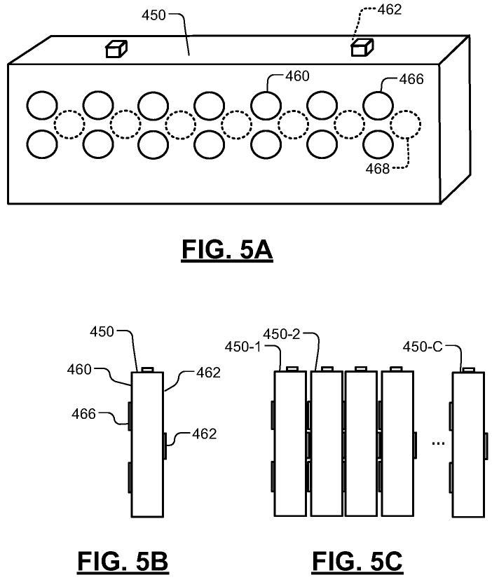

Referring now to FIGS. 4A to 4C, an example a battery cell 400 with stiffening beads 416 and 418 is shown. In FIGS. 4A and 4B, the stiffening beads 416 and 418 on opposite sides 410 and 412 are arranged offset from one another to allow nesting of stiffening beads of adjacent battery cells 400-1, 400-2, . . . , and 400-C shown in FIG. 4C, which reduces space.

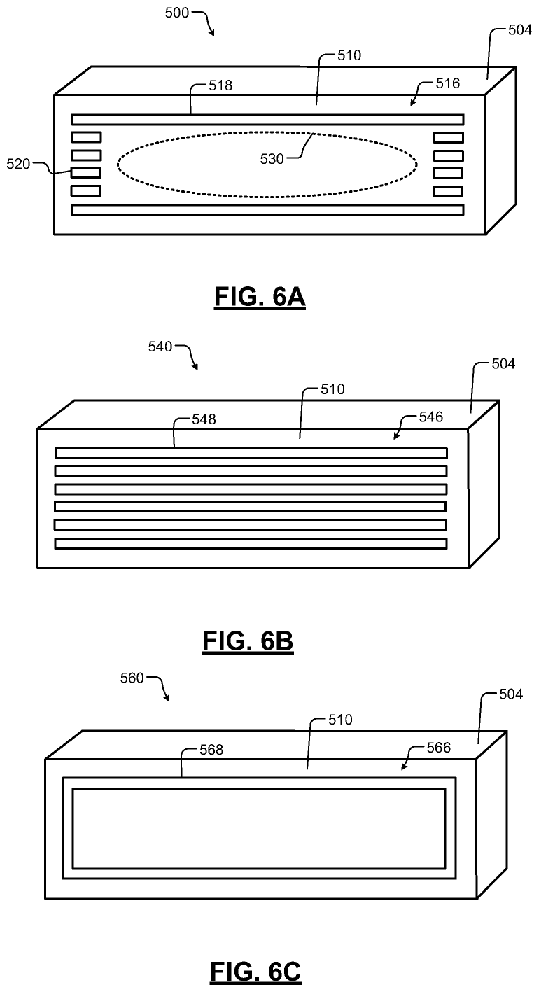

Referring now to FIGS. 5A to 5C, an example a battery cell 450 with stiffening dimples 466 and 468 is shown. In FIGS. 5A and 5B, the stiffening dimples 466 and 468 on opposite sides 460 and 462 are arranged offset from one another to allow nesting of stiffening dimples of adjacent battery cells 450-1, 450-2, . . . , and 450-C shown in FIG. 5C, which reduces space.

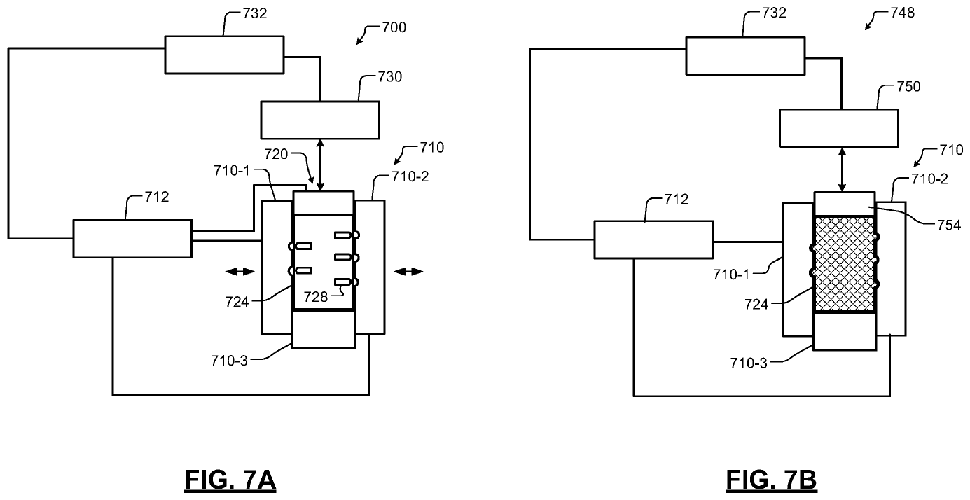

Referring now to FIG. 6A, a battery cell 500 includes an enclosure 504 with one or more sides 510 including a first or peripheral region 516 and a second or central region 530 (e.g., arranged inside the peripheral region 516). The central region 530 of the sides 510 of the battery enclosure is usually the hottest location when thermal runaway events occur. In some examples, stiffening portions are omitted in regions of the enclosure that tend to be hotter such as the central region 530 of the sides 510. Stiffening portions 518 and 520 are arranged in the peripheral region 516 (whereas the central region 530 does not include stiffening portions).

The battery enclosure in FIG. 6A helps to limit heat transfer or propagation between adjacent battery cells. There are no beads or dimples in the central region 530 where one or both of the adjacent battery cells are the hottest. In some examples, thermal insulating material or thermal interface material and a cooling plate (shown below) are arranged between the central regions 530 of the adjacent battery cells.

In FIG. 6B, a battery cell 540 includes an enclosure 504 with one or more sides 510 including a pattern 546 of stiffening beads 548 extending in parallel in a horizontal direction. In FIG. 6C, a battery cell 560 includes an enclosure 504 with one or more sides 510 including a pattern 566 of stiffening beads 568 extending in parallel in both horizontal and vertical directions. For example, a rectangular pattern with interconnected horizontal and vertical beads can be used.

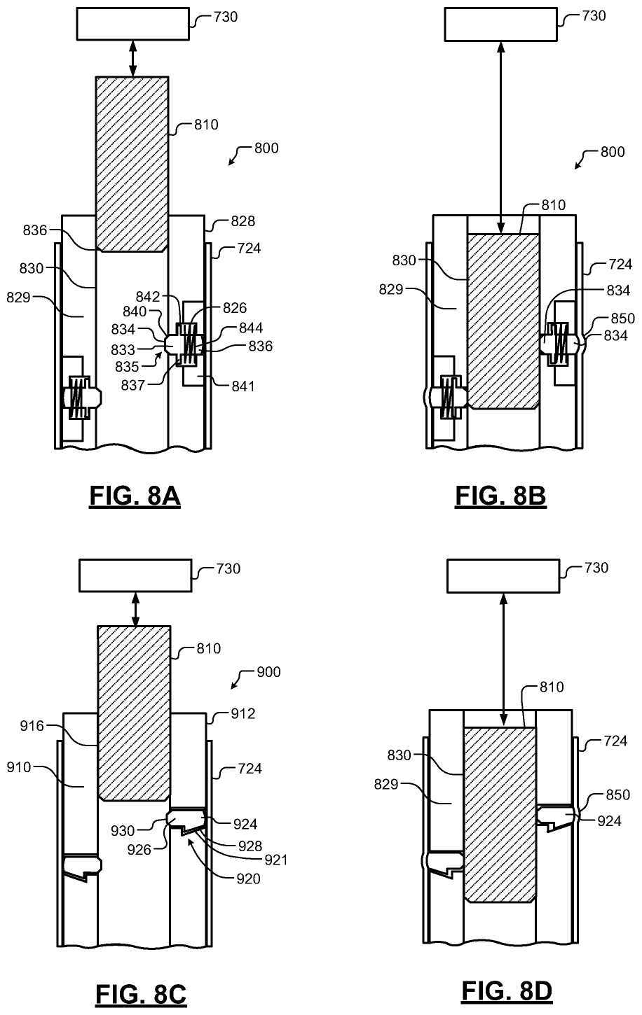

Referring now to FIG. 7A, a tool 700 includes one or more dies 710 and an expandable punch 720. In some examples, the one or more dies 710 comprise split dies 710-1 and 710-2 arranged around the enclosure above a lower die surface 710-3. A positioning device 712 may be used to arrange an enclosure body 724 on the lower die surface 710-3 and to open and close the dies 710-1 and 710-2 around the side surfaces of the enclosure body 724.

When the enclosure body 724 is arranged in the tool 700, the expandable punch 720 is inserted into an inner cavity of the enclosure body 724. The expandable punch 720 includes one or more punches 728 that are physically or hydraulically driven outwardly or laterally into an inner surface of the enclosure body 724 by an actuator 730. In some examples, the actuator 730 includes a physical punch that moves in a first direction and contacts and physically biases the one or more punches 728 in a second direction. In some examples, the second direction is transverse to or at an acute angle relative to the first direction.

In other examples, the actuator 730 is a hydraulic actuator that supplies high pressure liquid or pressurizes hydraulic liquid in the expandable punch 720. The high pressure of the hydraulic liquid biases the punches 728 outwardly into the inner surface of the enclosure body 724. A controller 732 is configured to control the positioning device 712 and/or the actuator 730.

Referring now to FIG. 7B, a tool 748 is similar to the tool shown in FIG. 7A. The tool 748 includes an actuator 750 and a seal/punch 754. After the enclosure body 724 is located in the tool 748, the positioning device 712 arranges the seal/punch 754 over an open end of the enclosure body 724 to provide a liquid seal. Liquid is supplied to the cavity of the enclosure body 724. The pressure of the liquid is increased by applying pressure to the seal/punch 754. The high pressure liquid forces the side walls of the enclosure body 724 outwardly into cavities (shown below) defined on inwardly facing surfaces of the dies 710 to form to the stiffening portions.

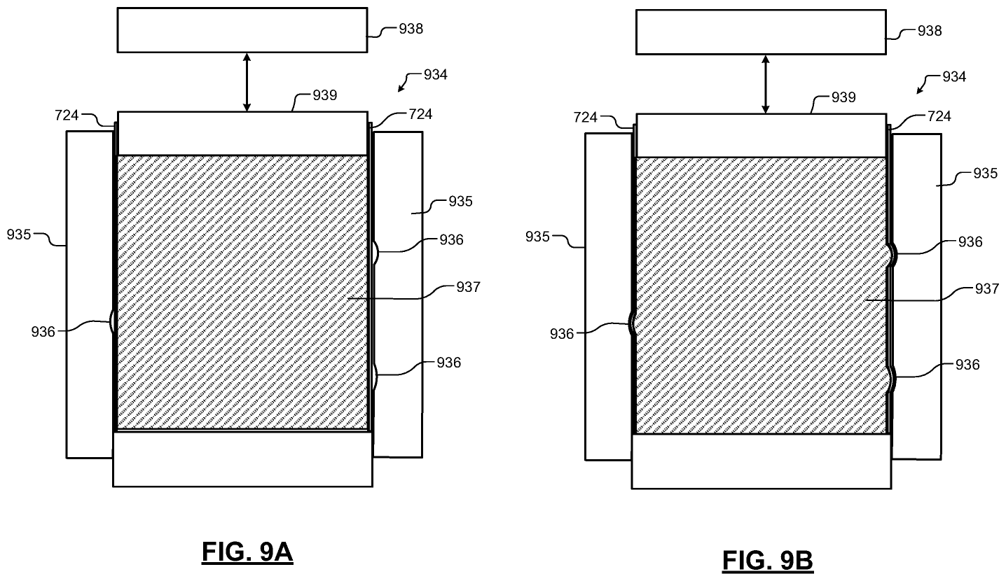

Referring now to FIGS. 8A to 8D, examples of expandable physical punches are shown. In FIGS. 8A and 8B, an expandable physical punch 800 includes an inner punch 810 and an outer punch 828. The expandable physical punch 800 is inserted into the enclosure body 724. The enclosure body 724 is surrounded by the die (as shown above). The outer punch 828 includes side walls 829 defining an inner cavity 830. The outer surfaces of the side walls 829 are arranged adjacent to inner surfaces of side walls of the enclosure body 724. During formation of the stiffening features, the inner punch 810 is inserted into the inner cavity 830 to bias the punches 834 arranged in the side walls 829 of the outer punch 828 outwardly into the side walls of the enclosure body 724. The punches 834 move from a withdrawn position (FIG. 8A) to a stamping position (FIG. 8B) to stamp one or more side walls of the enclosure body 724 when biased outwardly by the inner punch 810.

The side walls 829 and removeable wall portions 841 define a cavity 842 to receive the punches 834. In some examples, the removeable wall portions 841 can be removed to allow replacement of the punches 834. The punches 834 include a body 833 with an inner end 835 and an outer end 836. The inner end 835 extends into the inner cavity 830 when in the withdrawn position. During punching, the outer end 836 is biased into the inner surface of the side walls of the enclosure body 724. In some examples, the punches 834 include the body 833 and a projection 837 (e.g., an annular projection extending transversely relative to a longitudinal length the body). In some examples, a spring 844 is arranged between the removeable wall portions 841 and the projection 837 of the punches 834 to bias the punches 834 into the withdrawn position. In some examples, the outer ends 836 of the inner punch 810 and edges 840 of the punches 834 are inclined at an acute relative to a direction that the inner punch moves reciprocally.

In FIGS. 8C and 8D, another example of an expandable physical punch 900 is shown. Side walls 910 of an outer punch 912 define an inner cavity 916 to receive the inner punch 810. The side walls 910 further define cavities 920 with an inclined surface 921. The cavities 920 receive punches 924 including a body 926 with an inclined surface 928. Gravity causes the inclined surfaces 928 of the punches 924 to move along the inclined surfaces 921 of the cavities to bias the punches 924 towards the withdrawn position. The inner punch 810 biases inner ends 930 of the punches outwardly to cause the outer ends 932 to stamp the stiffening portions on the enclosure body 724 as shown in FIG. 8D.

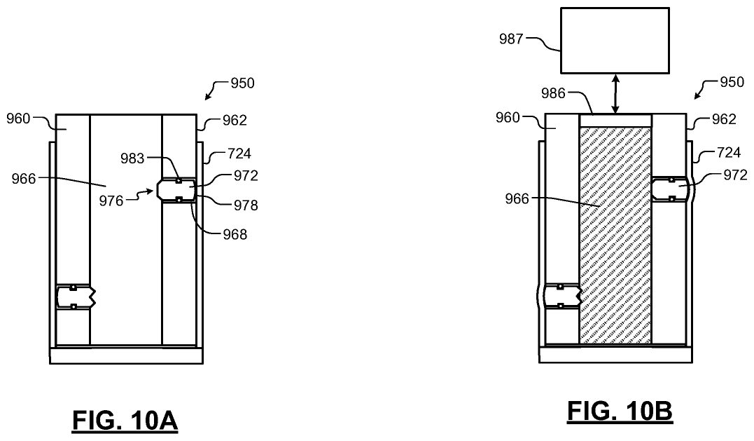

Referring now to FIGS. 9A and 9B, a hydroforming tool 934 can be used to form the stiffening portions on the enclosure body 724. In FIG. 9A, the hydroforming tool 934 includes dies 935 including cavities 936 in locations corresponding to the stiffening portions. The enclosure body 724 is inserted into a cavity defined between the dies 935. Liquid at least partially fills the cavity of the enclosure body 724. A seal/punch 939 is inserted into a cavity of the enclosure body 724 to compress the liquid to increase pressure in the cavity. When the liquid pressure is increased sufficiently, the liquid forces the side walls into the cavities 936 to create the stiffening portions (FIG. 9B).

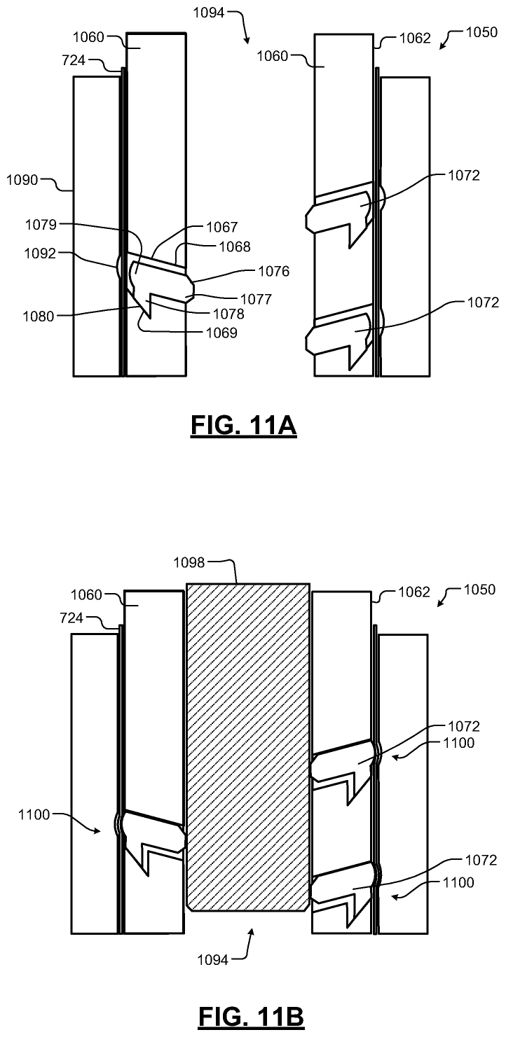

In FIGS. 10A and 10B, an example of an expandable hydraulic punch 950 is shown. Side walls 960 of an outer punch 962 define an inner cavity 966. The side walls 960 further define cavities 968 to reciprocally receive punches 972. The punches 972 include inner ends 976 and outer ends 978. An actuator 987 applies pressure onto a seal/punch 986 that applies pressure to the liquid in the enclosure body 724 to increase pressure and cause the punches 972 to move laterally into the enclosure body 724 to stamp the stiffening features in the enclosure body 724. The liquid transmits pressure to the punches 972 without direct contact, which reduces wear. After the liquid pressure is released, the punches 972 return to the withdrawn position.

In some examples, pressures in a range from 50 to 300 MPa are used. In some examples, the stiffening portions have a width in a range from 2 to 6 mm and a depth in a range from 0.2 mm to 0.5 mm. In some examples, the stiffening portions extend around corners of the enclosure.

The liquid applies sufficient pressure to bias the inner ends 976 of the punches 972 outwardly. The outer ends 978 are biased into the inner surface of the side walls of the enclosure body 724 to form the stiffening portions. In some examples, a seal 983 (e.g., an O-ring) provides a seal between the punches 972 and the cavities 968.

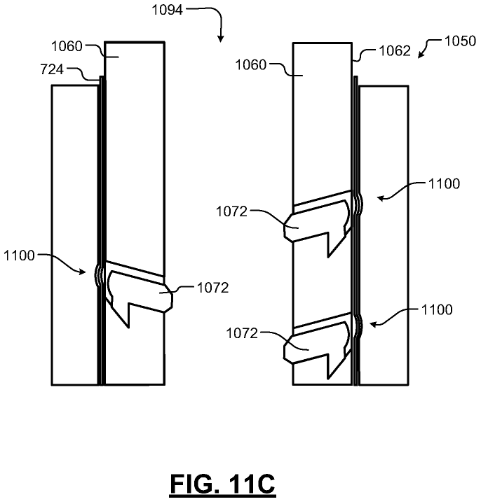

Referring now to FIGS. 11A to 11C, another example of an expandable physical punch 1050 is shown. In FIG. 11A, side walls 1060 of an outer punch 1062 define cavities 1067. The cavities 1067 include one or more inclined surfaces 1068, 1069, etc. that are inclined at an acute angle relative to a direction that an inner punch (not shown) moves reciprocally (e.g., vertical). The cavities 1067 receive punches 1072 including a projection 1078 with an inclined surface 1080. The punches 1072 may also include an inclined surface 1076 at an inner end 1077. A split die 1090 includes cavities 1092 aligned with the punches 1072 when the punches 1072 are in a stamping position.

In FIG. 11A, the punches 1072 are biased by gravity along the inclined surfaces to the withdrawn position with inner ends 1077 extending into an inner cavity 1094 of the outer punch 1062. Outer ends 1079 of the punches are spaced from the side walls of the enclosure body 724. In FIG. 11B, an inner punch 1098 moves into an inner cavity 1094 and biases the inner ends 1077 of the punches 1072 in an outward and upward direction into the inner surface of the sidewalls of the enclosure body 724 to create stiffening portions in the enclosure body 724 at 1100. In FIG. 11C, the inner punch 1098 is removed and the punches 1072 move to the withdrawn position due to gravity.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing an enclosure comprising:
one of extruding and deep drawing an enclosure body, wherein the enclosure body includes a plurality of side walls defining a first cavity, and wherein the plurality of side walls are formed without stiffening portions; and
after the one of the extruding and deep drawing of the enclosure body, forming a plurality of stiffening portions on the enclosure body.

2. The method of claim 1, wherein forming the plurality of stiffening portions includes:
surrounding the plurality of side walls of the enclosure body using a die;
inserting an outer punch of an expandable physical punch into the first cavity of the enclosure body,
wherein the outer punch includes a plurality of punches and a plurality of side walls defining a second cavity and a plurality of side wall cavities configured to receive the plurality of punches; and
inserting an inner punch in the second cavity to bias the plurality of punches from a withdrawn position to a stamping position to stamp a plurality of stiffening portions in at least one of the plurality of side walls of the enclosure body.

3. The method of claim 1, wherein:
the plurality of stiffening portions comprise at least one of a dimple and a stiffening bead, and
the enclosure body is made of one of stainless steel, aluminum, and alloys thereof.

4. The method of claim 1, wherein the plurality of stiffening portions extend outwardly from an outer side surface of the enclosure body.

5. The method of claim 2, wherein the plurality of punches include a body and a projection extending transversely from the body.

6. The method of claim 5, further comprising biasing the projection of the plurality of punches using a spring towards the withdrawn position of the plurality of punches.

7. The method of claim 2, wherein the plurality of side wall cavities include first inclined surfaces and the plurality of punches includes bodies with second inclined surfaces.

8. The method of claim 2, wherein the plurality of punches are inclined at an acute angle relative to a direction that the inner punch moves.

9. The method of claim 2, wherein the plurality of punches move in a direction that is transverse relative to a direction that the inner punch moves.

10. The method of claim 2, wherein edges of inner ends of the plurality of punches are inclined at an acute angle relative to a direction that the inner punch moves.

11. The method of claim 1, wherein a first pattern of the stiffening portions on one of the plurality of side walls of the enclosure body is complementary to a second pattern of the stiffening portions on another one of the plurality of side walls of the enclosure body to allow nesting of adjacent ones of the enclosure body.

12. The method of claim 1, wherein forming the plurality of stiffening portions includes:
surrounding the plurality of side walls of the enclosure body using a die;
inserting an outer punch of an expandable physical punch into the first cavity of the enclosure body,
wherein the outer punch includes a plurality of punches and a plurality of side walls defining a second cavity and a plurality of side wall cavities configured to receive the plurality of punches;
sealing the second cavity;
supplying liquid to the second cavity; and
biasing the plurality of punches into the plurality of side walls of the enclosure body using the liquid to stamp a plurality of stiffening portions in the plurality of side walls of the enclosure body.

13. The method of claim 12, further comprising sealing the plurality of punches relative to the side wall cavities.

14. The method of claim 13, wherein sealing the plurality of punches relative to the plurality of side wall cavities includes arranging an “O”-ring between the plurality of punches and the plurality of side wall cavities.

15. The method of claim 2, wherein forming the plurality of stiffening portions includes:
surrounding the plurality of side walls of the enclosure body using a die including a plurality of second cavities; and
using liquid in the first cavity of the enclosure body to drive the side walls into the plurality of second cavities to create a plurality of stiffening portions on the side walls of the enclosure body.

16. An enclosure for a battery cell comprising:
an enclosure body formed by one of extruding and deep drawing and including a plurality of side walls defining a first cavity; and
a plurality of stiffening portions formed in at least one of the plurality of side walls of the enclosure body after the one of extruding and deep drawing.

17. The enclosure of claim 16, wherein the plurality of stiffening portions comprise at least one of a dimple and a stiffening bead.

18. The enclosure of claim 16, wherein the enclosure body is made of one of stainless steel, aluminum, and alloys thereof.

19. The enclosure of claim 16, wherein the plurality of stiffening portions extend outwardly from an outer side surface of the enclosure body.

20. The enclosure of claim 16, wherein a first pattern of the stiffening portions on one of the plurality of side walls of the enclosure body is complementary to a second pattern of the stiffening portions on another one of the plurality of side walls of the enclosure body to allow nesting of adjacent ones of the enclosure body.
